(19) United States
(12) Patent Application Publication
(10) Pub. No.: US 2002/0175678 A1
(43) Pub. Date: Nov. 28, 2002

(54) Arrangement for determining the position of a motion sensor element

(76) Inventor: Stefan Butzmann, Hamburg (DE)

Correspondence Address: U.S. Philips Corporation, 580 White Plains Road, Tarrytown, NY, 10591, US

(21) Appl. No.: 10/122,792

(22) Filed: Apr. 12, 2002

(30) Foreign Application Priority Data
Apr. 17, 2001 (DE) 10118819.6

(51) Int. Cl. G01B 7/30; G01B 7/14

(52) U.S. Cl. 324/207.25; 324/207.24; 324/207.2; 324/207.21

(57) ABSTRACT

An arrangement is described for determining the position of a motion sensor element influencing the formation of a magnetic field periodically along its motion co-ordinate, the arrangement comprising a sensor element which is sensitive along a measuring direction to at least the polarity of the magnetic field and is adapted to supply a measuring signal in dependence upon a field component of the magnetic field, denoted as measuring field and measured in the measuring direction, the measuring direction of the sensor element being aligned at least substantially right-angled to the motion co-ordinate of the motion sensor element.

The invention thereby provides an arrangement for determining the position of a motion sensor element with a “true power-on” facility.

The invention relates to an arrangement for determining the position of a motion sensor element.

Arrangements for measuring the rotational speed of a rotating motion sensor element comprising a sensor element utilizing the magnetoresistive effect have been described. This magnetoresistive sensor element comprises four permalloy strips which are arranged on a silicon substrate in a meandering pattern and configured as a Wheatstone bridge. The magnetoresistive sensor element is sensitive along a measuring direction to the polarity and the field strength of an external magnetic field and adapted to supply a measuring signal in dependence upon a field component of the magnetic field, denoted as measuring field and measured in the measuring direction.

Since, due to the magnetoresistive effect, a rotational movement of the motion sensor element cannot be directly measured, a permanent magnet denoted as working magnet is additionally fixed to the magnetoresistive sensor element. This working magnet is stuck to the rear side of the magnetoresistive sensor element or its housing so that the magnetoresistive sensor element is permeated with the magnetic field of the working magnet, although in this assembly itself a field component of the magnetic field will not occur in the measuring direction without the motion sensor element. The measuring signal supplied by the magnetoresistive sensor element is equal to zero in this configuration.

When a motion sensor element formed like a gear-wheel of a ferromagnetic material is arranged in the vicinity of the sensor, this will lead to a change of the field variation of the magnetic field of the working magnet. To this end, the measuring direction of the magnetoresistive sensor element is aligned in the direction of movement of the motion sensor element with respect to the teeth of the motion sensor element formed like a gear-wheel of ferromagnetic material. The teeth of the motion sensor element thus move past the sensor element in this measuring direction. Along the motion co-ordinate of the motion sensor element coinciding with the measuring direction, this leads to a distortion of the field lines of the magnetic field of the working magnet in the measuring direction of the sensor element, which distortion occurs periodically with respect to the distance between the teeth of the gear-wheel-like shape of the motion sensor element. In a “symmetrical” position, in which the sensor element is centered in front of a tooth or in a gap between two teeth, the magnetic field is not distorted in the direction of movement of the motion sensor element, so that the output signal of the sensor element is equal to zero in this position. In a “non-symmetrical” position, in which the sensor element is neither centered in front of a tooth or a gap, the magnetic field is distorted in the direction of movement of the motion sensor element, which depends on the motion co-ordinate of the motion sensor element. The sensor element thereby generates an output signal which is dependent on this motion co-ordinate of the motion sensor element, which output signal may be preferably at least substantially sinusoidal on the motion co-ordinate.

A magnetized motion sensor element has also been described, in which magnetic north and south poles of alternating polarity are arranged along its direction of movement. In this form, the motion sensor element itself provides the magnetic field and thereby also the measuring field.

Such magnetoresistive sensor elements are used together with rotating motion sensor elements in diversified systems for detecting the number of revolutions of wheels, shafts or the like, coupled to the motion sensor elements. One of the most principal fields of application is their use in anti-blocking systems or as crankshaft rotational sensors in motor vehicles. The sensor is then conventionally operated in front of a gear-wheel of a magnetizable material, with four resistors connected in a Wheatstone bridge configuration, in which the measuring direction, i.e. the magnetically sensitive direction of the sensor element is parallel to the rotational direction co-ordinate of the gear-wheel in the manner described.

As described, the output signal of the Wheatstone bridge can be represented in a first approximation by a sinusoidal signal on the motion co-ordinate of the motion sensor element, in which the zero-crossings in the output signal occur before the center of a tooth or before the center of a gap between two teeth of the motion sensor element. In the case of a moved motion sensor element, the position of the motion sensor element with respect to the sensor element can be unambiguously determined from the output signal.

The arrangement described hereinbefore has the drawback that, for an unambiguous determination of the position of the motion sensor element along the motion co-ordinate, the motion sensor element must be in motion. Directly after putting the sensor element into operation, i.e. after switching on the power supply, no unambiguous determination of the position is possible because the output signal is not unambiguous. For example, an output signal of the Wheatstone bridge with a value of zero may mean that the sensor element is right in front of a tooth or right in front of a gap. This is particularly a drawback when the motion sensor element is subdivided into a small number of teeth as in, for example, camshafts of vehicle motors.

In many applications, as in, for example, the detection of the number of revolutions of camshafts or during operation of crankshaft starter generators, an unambiguous determination of the position of the motion sensor element is desired right upon the start of operations. This possibility of unambiguously determining the position of the motion sensor element right upon the start of operations is also denoted as “true power-on” facility.

It is an object of the invention to provide an arrangement for determining the position of a motion sensor element with such a true power-on facility.

According to the invention, this object is solved by an arrangement for determining the position of a motion sensor element influencing the formation of a magnetic field periodically along its motion co-ordinate, the arrangement comprising a sensor element which is sensitive along a measuring direction to at least the polarity of the magnetic field and is adapted to supply a measuring signal in dependence upon a field component of the magnetic field, denoted as measuring field and measured in the measuring direction, the measuring direction of the sensor element being aligned at least substantially right-angled to the motion co-ordinate of the motion sensor element.

This arrangement provides the simple possibility of gaining an output signal from the sensor element with an unambiguous assignment of the motion sensor element to the position of the sensor element.

Particularly, arranged in a strip-shaped zone of a main surface extending along the motion co-ordinate of the motion sensor element, said motion sensor element comprises periodically recurrent areas alternately influencing the measuring field which is being formed parallel to the main surface and is at least substantially right-angled to the motion co-ordinate of the motion sensor element, and the measuring direction of the sensor element is aligned at least substantially parallel to the main surface of the motion sensor element.

In a further embodiment of the invention, the motion sensor element comprises two strip-shaped zones of periodically recurrent areas alternately influencing the measuring field, which zones are offset in the direction of the motion co-ordinate of the motion sensor element by at least substantially half a period of the areas alternately influencing the measuring field.

As compared with the configurations mentioned hereinbefore, with an orientation of the measuring direction of the sensor element parallel to the direction of movement of the motion sensor element, it can be unambiguously concluded from the polarity of the output signal of the sensor element in the arrangement according to the invention which area alternately influencing the measuring field is instantaneously situated in front of the sensor element without this first requiring a relative movement between the motion sensor element and the sensor element. As a result, an unambiguous detection of the position of the motion sensor element along its motion co-ordinate is possible, thus providing the above-mentioned true power-on facility.

In a preferred embodiment of the invention, the zones of periodically recurrent areas alternately influencing the measuring field are constituted by projections alternating with indentations substantially perpendicular to the main surface of the motion sensor element, which projections and indentations are formed from a magnetizable material comprised by the motion sensor element. The motion sensor element is particularly formed from a ferromagnetic material and has a shape which is similar to a gear-wheel. Thus, a tooth-gap configuration, in which the teeth influence the measuring field in a different way than the gaps, extends along the motion co-ordinate of the motion sensor element. In an example of the simplest form with only one zone of periodically recurrent areas alternately influencing the measuring field, the motion sensor element is substantially formed as a simple gear-wheel, as already described. In this case, a very simple realization of the arrangement according to the invention is possible. In an example of a further form with two zones of periodically recurrent areas alternately influencing the measuring field, the motion sensor element may consist of two such gear-wheels which are axially joined together and rotationally offset with respect to each other in the circumferential direction by at least substantially half a distance between two neighboring teeth at the circumference.

The configurations in accordance with the above-mentioned further embodiments of the invention preferably comprise a working magnet for impressing the magnetic field on the arrangement, in which the principal direction of the magnetic field lines of the magnetic field emanating from the working magnet is aligned at least substantially right-angled to the motion co-ordinate of the motion sensor element as well as to the measuring direction of the sensor element. This working magnet, which is particularly formed as a permanent magnet, corresponds to the form mentioned above for the arrangements for measuring the rotational speed as described above. This recourse to construction elements which are already provided simplifies the manufacture of the arrangement according to the invention.

In a further embodiment of the invention, the zones of periodically recurrent areas alternately influencing the measuring field are constituted by alternating, opposite magnetic poles of a magnetized material comprised by the motion sensor element. In this embodiment of the motion sensor element, which is also referred to as “magnetized encoder”, the motion sensor element itself supplies the magnetic field so that a separate working magnet is not required. However, the sensor element may be connected to an additional supporting magnet supplying only a weak magnetic field, which has a stabilizing effect.

Particularly in the embodiment of the motion sensor element with only one strip-shaped zone of periodically recurrent areas alternately influencing the measuring field, the sensor element is arranged opposite or next to a peripheral area, which is lateral with respect to the direction of movement, of the strip-shaped zone of periodically recurrent areas alternately influencing the measuring field of the motion sensor element. The sensor element is thus “offset at the periphery” transversely to the direction of movement of the motion sensor element. The measuring field is formed by the shape of the magnetic field at this lateral peripheral area in which noticeable magnetic field components occur at right angles to the direction of movement of the motion sensor element. This yields an arrangement which operates very effectively.

In a preferred embodiment of the invention, the sensor element is a magnetoresistive sensor element, referred to as “MR sensor”.

In a further embodiment of the invention, in which the motion sensor element comprises two strip-shaped zones of periodically recurrent areas alternately influencing the measuring field, the sensor element is formed as a differential Hall sensor element with two sub-sensor elements, a respective one of which is arranged opposite a respective one of the zones of periodically recurrent areas alternately influencing the measuring field. The sub-sensor elements supply different signals dependent on their respective position in front of the areas alternately influencing the measuring field. A differential signal for further evaluation is derived from these signals.

In accordance with a further embodiment of the invention, the motion sensor element may be linear. In this form, it can be advantageously used for linear motion pick-up devices. In another preferred embodiment, the motion sensor element is rotationally symmetrical and suitable for rotational motion pick-up devices.

These and other aspects of the invention are apparent from and will be elucidated with reference to the embodiments described hereinafter.

In the drawings:

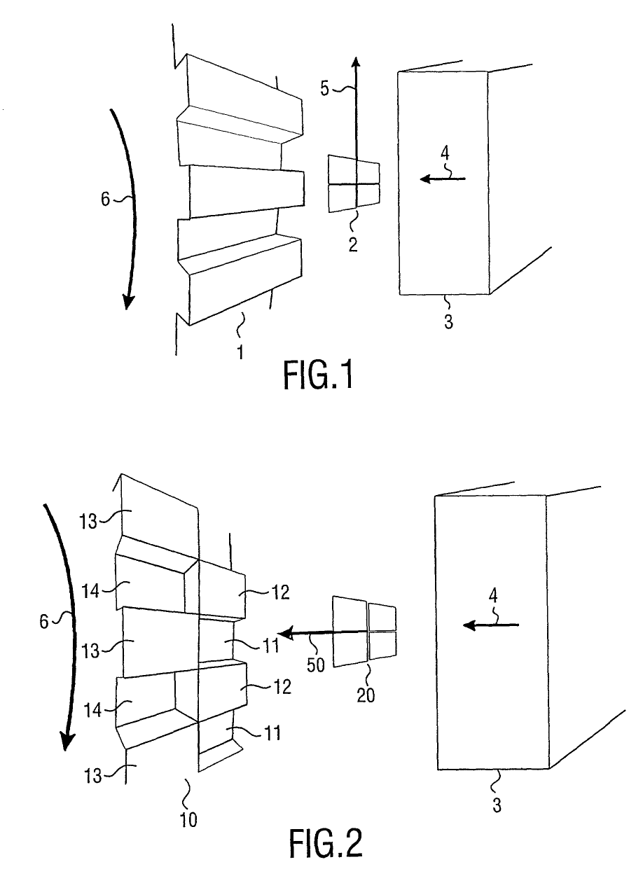

FIG. 1 shows an arrangement in which the measuring direction of the sensor element is parallel to the direction of movement of the motion sensor element, and

FIG. 2 shows an embodiment of an arrangement according to the invention.

In the arrangement shown in FIG. 1, the reference numeral 1 denotes a toothed wheel, or gear-wheel, of a magnetizable material which constitutes a motion sensor element and rotates in a direction of movement indicated by the arrow 6. Arranged in front of the teeth of the gear-wheel 1 is a sensor element 2 whose measuring direction is indicated by means of an arrow denoted by reference numeral 5 and is aligned parallel to the direction of movement 6. A magnet 3 formed as a permanent magnet and constituting a working magnet is arranged behind the sensor element 2, which magnet impresses a magnetic field, here denoted as magnetization 4, on the arrangement consisting of the gear-wheel 1 and the sensor element 2, while the principal direction of the magnetic field lines of the magnetic field—magnetization 4—emanating from the working magnet is aligned substantially right-angled to both the motion co-ordinate of the gear-wheel 1, i.e. its direction of movement 6, and the measuring direction 5 of the sensor element 2.

In this arrangement, the teeth of the gear-wheel 1 constitute a strip-shaped zone of periodically recurrent areas alternately influencing a measuring field which is formed by a field component of the magnetic field 4 parallel to the direction of movement 6 and is not explicitly shown in FIG. 1. This measuring field is produced by the excursion of the magnetic field lines towards the flanks of the teeth of the gear-wheel 1.

FIG. 2 shows an embodiment of an arrangement according to the invention in which elements corresponding to those in FIG. 1 are denoted by the same reference numerals.

In this arrangement, a gear-wheel 10 comprising two strip-shaped zones of periodically recurrent areas alternately influencing the measuring field is used instead of the gear-wheel 1 in the configuration shown in FIG. 1, which zones are offset by at least substantially half a period of the areas alternately influencing the measuring field in the direction of the motion co-ordinate of the motion sensor element. In the gear-wheel 10, these strip-shaped zones are constituted by two sets of teeth which are arranged axially next to each other and are offset in the direction of movement 6 of the gear-wheel, i.e. in its circumferential direction, by half a distance of two consecutive teeth. Consequently, each tooth of a first set of teeth is adjacent to a gap of the second set of teeth and, conversely, each gap of the first set of teeth is adjacent to a tooth of the second set of teeth. For example, a tooth 13 in the second set of teeth is adjacent to a gap 11 in the first set of teeth, and a tooth 12 adjoining the gap 11 in the first set of teeth is adjacent to a gap 14 adjoining the tooth 13 in the second set of teeth.

The arrangement shown in FIG. 2 includes a sensor element 20 whose structure corresponds to that of the sensor element 2 in the arrangement shown in FIG. 1, but now its measuring direction 50 is rotated by 90° with respect to that in FIG. 1 and points in the axial direction of the gear-wheel 10. The measuring field in front of each mating of one tooth on one of the sets of teeth with a gap of the respective one of the other set of teeth is now constituted by the distortions of the magnetic field lines of the magnetic field (“magnetization”) 4 of the magnet 3 in the axial direction of the gear-wheel 10, i.e. alternating with the teeth 13, 12, etc. of the two sets of teeth of the gear-wheel 10. The measuring field is alternately oriented in either the same or the opposite sense to the measuring direction. Accordingly, the sensor element 20 alternately supplies either a positive or a negative output signal upon a rotation of the gear-wheel 10. For example, in the position of the gear-wheel 10 in which the mating of gap 11 with tooth 13 is situated in front of the sensor element 20, the field lines of the magnetic field 4 are deflected in the measuring direction 50, namely towards tooth 13, which yields a measuring field in the positive measuring direction 50 and hence corresponds to a positive output signal. When the gear-wheel 10 is further rotated until the mating of tooth 12 with gap 14 is situated in front of the sensor element 20, the field lines of the magnetic field 4 are deflected in the opposite direction, i.e. opposed to the measuring direction 50, in front of the mating of gap 14 with tooth 12, which yields a measuring field in the negative measuring direction 50 and hence corresponds to a negative output signal.

As regards the output signal of the sensor element 20, the offset between the two sets of teeth in the circumferential direction, i.e. in the direction of movement 6, by half a distance between two consecutive teeth involves an (electrical) shift by 180°.

The arrangement according to the invention ensures that, also in gear-wheels having a coarse pitch, an unambiguous assignment of the output signal of the sensor element 20 to a given position of the motion sensor element 10 along the motion co-ordinate, i.e. in the direction of movement 6, is always given.

The arrangement described hereinbefore may also be used in conjunction with Hall sensors for a state recognition which is independent of distances and is therefore not limited to the use of MR sensors.

In a modification of the embodiment described hereinbefore a “conventional” gear-wheel 1 as shown in the arrangement in FIG. 1 is combined with a sensor element which is similar to the sensor element 20 shown in FIG. 2. In the arrangement thus obtained, the sensor element 20 and the magnet 3 are simultaneously offset on one of the outer edges of the gear-wheel 1—viewed in its axial direction. The measuring field is formed by axial field components of the magnetic field 4 in the area of the edge of the gear-wheel 1. In this case, a unipolar output signal is produced at the sensor element 20. The states in which a tooth or a gap are situated in front of the sensor element 20 can be distinguished from the amplitudes of this output signal.

1. An arrangement for determining the position of a motion sensor element influencing the formation of a magnetic field periodically along its motion co-ordinate, the arrangement comprising a sensor element which is sensitive along a measuring direction to at least the polarity of the magnetic field and is adapted to supply a measuring signal in dependence upon a field component of the magnetic field, denoted as measuring field and measured in the measuring direction, the measuring direction of the sensor element being aligned at least substantially right-angled to the motion co-ordinate of the motion sensor element.

2. An arrangement as claimed in claim 1, characterized in that, arranged in a strip-shaped zone of a main surface extending along the motion co-ordinate of the motion sensor element, said motion sensor element comprises periodically recurrent areas alternately influencing the measuring field which is being formed parallel to the main surface and is at least substantially right-angled to the motion co-ordinate of the motion sensor element, and the measuring direction of the sensor element is aligned at least substantially parallel to the main surface of the motion sensor element.

3. An arrangement as claimed in claim 2, characterized in that the motion sensor element comprises two strip-shaped zones of periodically recurrent areas alternately influencing the measuring field, which zones are offset in the direction of the motion co-ordinate of the motion sensor element by at least substantially half a period of the areas alternately influencing the measuring field.

4. An arrangement as claimed in claim 2 or 3, characterized in that the zones of periodically recurrent areas alternately influencing the measuring field are constituted by projections alternating with indentations substantially perpendicular to the main surface of the motion sensor element, which projections and indentations are formed from a magnetizable material comprised by the motion sensor element.

5. An arrangement as claimed in claim 4, characterized by a working magnet for impressing the magnetic field on the arrangement, in which the principal direction of the magnetic field lines of the magnetic field emanating from the working magnet is aligned at least substantially right-angled to the motion co-ordinate of the motion sensor element as well as to the measuring direction of the sensor element.

6. An arrangement as claimed in claim 2 or 3, characterized in that the zones of periodically recurrent areas alternately influencing the measuring field are constituted by alternating, opposite magnetic poles of a magnetized material comprised by the motion sensor element.

7. An arrangement as claimed in claim 2, characterized in that the sensor element is arranged opposite or next to a peripheral area, which is lateral with respect to the direction of movement, of the strip-shaped zone of periodically recurrent areas alternately influencing the measuring field of the motion sensor element.

8. An arrangement as claimed in claim 3 or any one of claims 4 to 6 where appendant to claim 3, characterized in that the sensor element is formed as a differential Hall sensor element with two sub-sensor elements, a respective one of which is arranged opposite a respective one of the zones of periodically recurrent areas alternately influencing the measuring field.

9. An arrangement as claimed in any one of claims 1 to 7, characterized in that the sensor element is a magnetoresistive sensor element.

10. An arrangement as claimed in any one of claims 1 to 9, characterized in that the motion sensor element is linear.

11. An arrangement as claimed in any one of claims 1 to 9, characterized in that the motion sensor element is rotationally symmetrical.
